(19) United States
(12) Patent Application Publication
(10) Pub. No.: US 2003/0122853 A1
(43) Pub. Date: Jul. 3, 2003

(54) Method for tracing enlarged region of moving picture

(76) Inventor: Jeong woo Kim, Seoul (KR)

Correspondence Address: BIRCH STEWART KOLASCH & BIRCH, PO BOX 747, FALLS CHURCH, VA, 22040-0747, US

(21) Appl. No.: 10/329,817

(22) Filed: Dec. 27, 2002

(30) Foreign Application Priority Data
Dec. 29, 2001 (KR) 88530/2001

(51) Int. Cl. G09G 5/00

(52) U.S. Cl. 345/660

(57) ABSTRACT

A method for tracing an enlarged region of a moving picture, capable of tracing and maintaining a region of interest in enlarging the region of interest of a user comprises setting a region of interest on the basis of a center of an enlarged region set by the user, abstracting displacement corresponding to the region of interest in a MPEG stream and reducing, enlarging or moving the enlarged region according to displacement of a region of interest.

### BACKGROUND OF THE INVENTION

1. Field of the Invention

The present invention relates to a method for tracing an enlarged region of a moving picture and particularly, to a method for tracing an enlarged region of a moving picture, capable of tracing and maintaining a region of interest in enlarging the region of interest of a user.

2. Description of the Background Art

Modern media industries have been rapidly spread into visual media, such as moving pictures, images and the like from media centering printing types by development the internet, digital TV and the like. Such visual media are inefficient in processing rate and capacity to directly process the original data since much amount of data, such as moving picture or image and the like and the quantity of calculation is too much. Therefore, to more efficiently manage data such as moving picture or image, compression algorithm such as moving picture experts group (hereinafter, as MPEG), joint photographic coding experts group (hereinafter, as JPEG) and the like was developed.

The compression algorithm processes data which were digitized, and can freely enlarge or reduce data according to kinds of media. For instance, DVD, digital TV, video CD and the like which are on sale at markets are composed so that a user can watch a enlarged specific region in a moving picture or an image by the above property.

On the other hand, researches on object-tracing for tracing movement of an object in continuous moving pictures are on the process. For instance, the object tracing method generates a moving condition by applying a motion vector algorithm which is applied in compressing or restoring the MPEG. Generally, in terms of artificial intelligence, a pattern recognition method and a method of tracing an object using the movement of a camera are researched.

These object-tracing methods are for tracing continuous object patters by recognizing the object by finding the pattern of the object by analyzing the corresponding image, and matching the pattern with the image. Also, for objects having relatively small amount of changes and small movement of the position of the camera, the moving method of the camera has been used to trace the object.

However, with the method for tracing the enlarged region of the moving picture using the above method, the position of the enlarged region selected by the user is fixed, but since the object selected by the user moves, reduces or enlarges continuously, it gets out of the enlarged region selected by the user. That is, a content to be watched in detail in tracing the enlarged region of the moving picture disappears from the screen. Therefore, the user must halt the screen featuring the content or must try to enlarge in a region where small amount of movements are performed.

### SUMMARY OF THE INVENTION

Therefore, an object of the present invention is to provide a method for tracing an enlarged region of a moving picture, capable of maintaining a region of interest by tracing the region by reducing, enlarging or moving the enlarged region according to displacements of the region of interest when a user enlarges a region.

To achieve these and other advantages and in accordance with the purpose of the present invention, as embodied and broadly described herein, there is provided a method for tracing an enlarged region of a moving picture which performs reducing, enlarging or moving the enlarged region according to the displacement of the region of interest set by the user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flow chart illustrating a method for tracing an enlarged region of a moving picture in accordance with the present invention;

FIGS. 2A and 2B are exemplary views showing a state that a region of interest is selected in a block shape having a predetermined size for an object to be enlarged from the moving picture;

FIGS. 3A to 3C are exemplary views showing a method for deciding zoom out by a displacement in the region of interest in respective directions;

FIGS. 4A to 4C are exemplary views showing a method for deciding zoom in by the displacement in the region of interest in respective directions; and

FIGS. 5A to 5C are exemplary views showing a state that the region of interest is moved in case the object on the screen is moved or the background region is moved.

### DETAILED DESCRIPTION OF THE PREFERRED EMBODIMENTS

Reference will now be made in detail to the preferred embodiments of the present invention, examples of which are illustrated in the accompanying drawings.

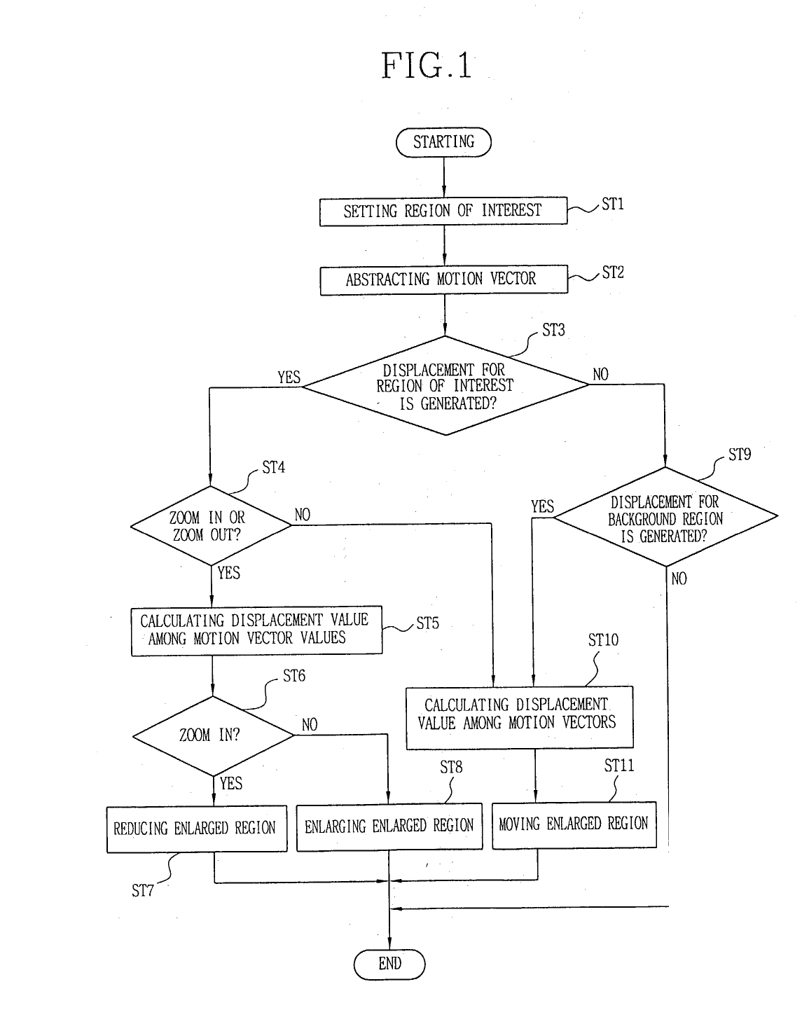

FIG. 1 is a flow chart illustrating a method for tracing an enlarged region of a moving picture in accordance with the present invention.

As shown in FIG. 1, the method for tracing the enlarged region of the moving picture comprises setting a region of interest on the basis of the center of an enlarged region which is set by a user (ST1), abstracting a displacement corresponding to the region of interest in the MPEG stream (ST2), deciding zoom in or zoom out when the displacement is generated (ST3 and ST4), reducing the enlarged region as long as the displacement by calculating the displacement in case the mode is zoom in (ST5, ST6 and ST7), enlarging the enlarged region as the displacement by calculating the displacement in case the mode is zoom out (ST5, ST6 and ST8), and moving the position of the enlarged region in the upper, lower, left and right directions as long as the displacement by calculating the displacement according to the movement of the object on the screen if the mode is not zoom in or zoom out (ST4, ST10, ST11).

Then, the above method further comprises deciding whether there is movement of the background region except the region of interest if the displacement of the region of interest is not generated (ST3 and ST9), and moving the position of the region of interest in the upper, lower, left and right directions as long as the displacement so that the region of interest is always positioned at the center of the screen by calculating the displacement of the background region.

On the other hand, in case the object in the region of interest disappears out of the screen, the enlarged region which was enlarged, reduced and moved is restored into the original screen.

In more detail, the method for tracing the enlarged region of the moving picture will be described as follows.

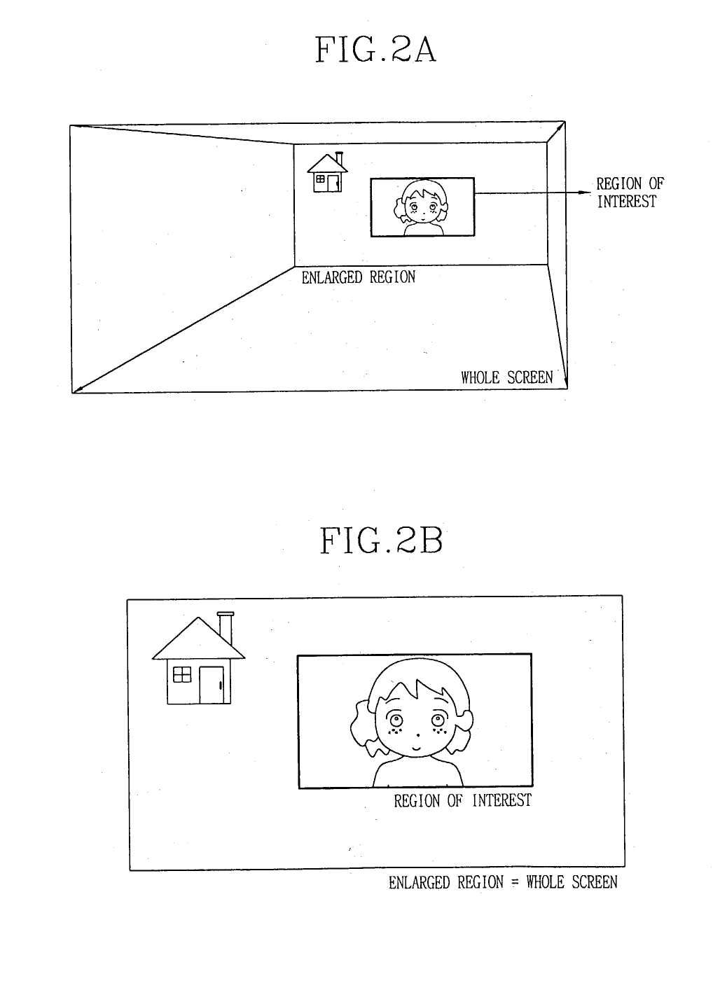

FIGS. 2A and 2B are exemplary views showing a state that a region of interest is selected in a block shape having a predetermined size for an object to be enlarged from the moving picture.

FIGS. 2A shows a state that a user selects an enlarged region to be enlarged. Here, the screen before enlarging is divided into an enlarged region and a region of interest by selection of the user. Also, FIG. 2B shows a state that a region of interest is enlarged by selection of the user. At this time, the enlarged region indicates the whole screen, and a box line showing the region of interest is not displayed on the real screen.

The region of interest is set on the basis of the center of the enlarged region set by the user. That is, it is regarded that the region of interest is at the center of the region enlarged by the user to abstract the region of interest. Therefore, a predetermined processing range according to the size of the object on the screen can be set differently. Here, the half size of the enlarged region set by the user was set as the region of interest.

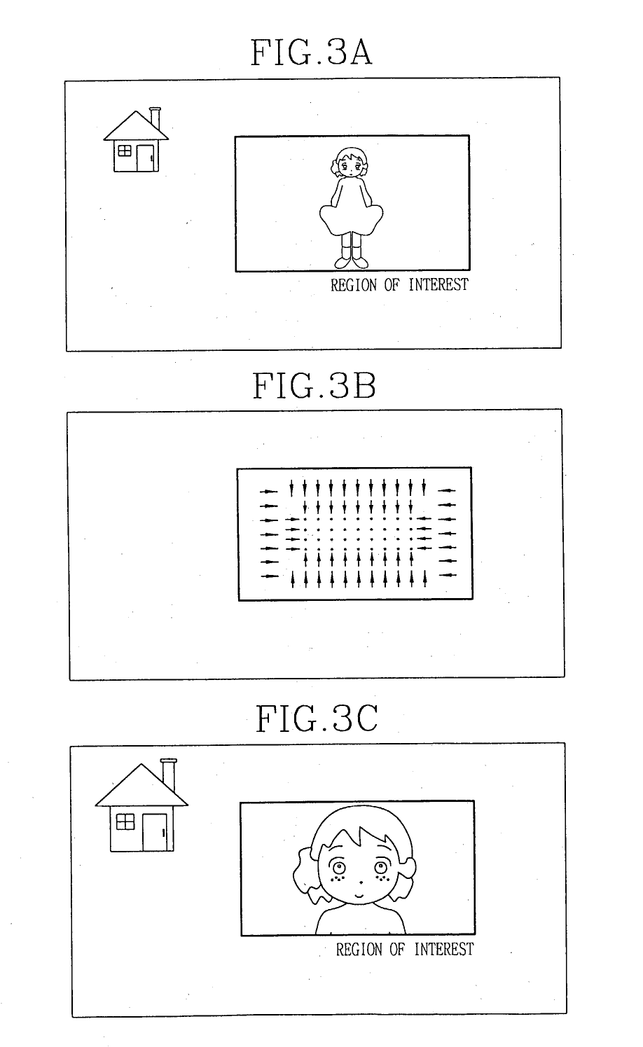

FIGS. 3A to 3C are exemplary views showing a method for deciding zoom out by a displacement in the region of interest in respective directions.

FIG. 3A shows a real screen of a case that there is a change in the screen (zoom out). Therefore, as shown in FIG. 3B, the size and direction of the motion vector face the inner side. Here, abstracting the motion vector is read from a MPEG stream including a header, motion vector and another additional information (ST2). Here, the motion vector means the parallel and vertical amount of displacement between the current macro block and a macro block in a reference screen from the MPEG stream, and is mainly performed in unit of macro blocks.

On the other hand, in presuming generation of displacement for the region of interest, an average value of absolute values of the motion vector in the region of interest is obtained, and in case the average value is larger than the preset critical value, it is regarded that there is movement (ST3). Therefore, the displacement of the region of interest was respectively obtained for four surfaces, and in case the value faces the inner side, the mode is decided as zoom out (ST4). Since it means that there occur changes in case of the zoom out, the displacement value among motion vectors is calculated as a standard for changing the size of the region of interest (ST5).

Then, as shown in FIG. 3C, the size of the region of interest is maintained so that the size of the object which will be enlarged as large as the displacement value becomes a predetermined value (ST6 and ST8).

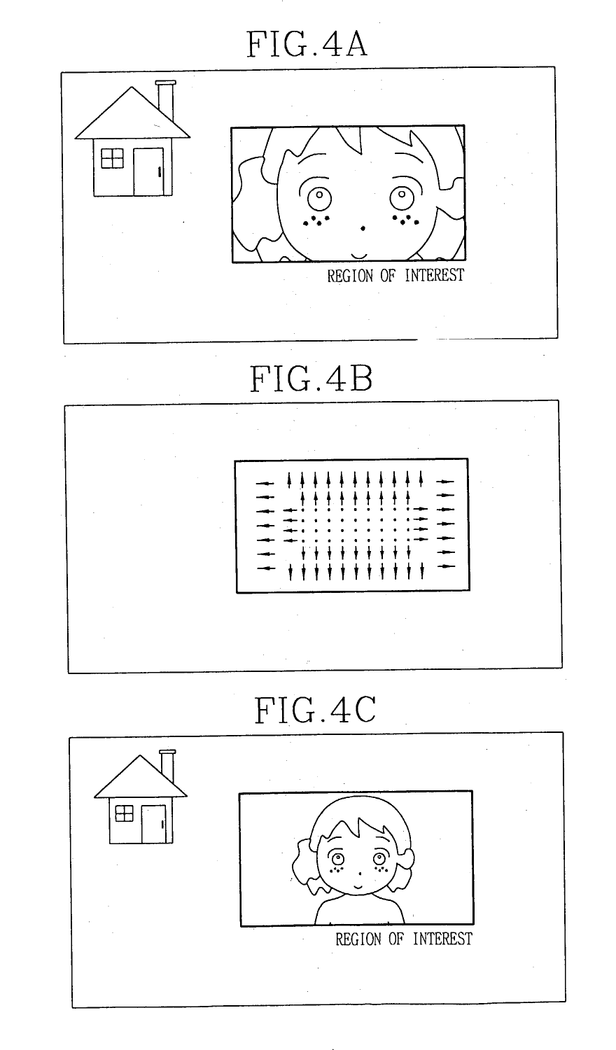

FIGS. 4A to 4C are exemplary views showing a method for deciding zoom in by the displacement in the region of interest in respective directions.

FIG. 4A shows a real screen in case there is a change in the screen (zoom in). Therefore, as shown in FIG. 4B, the size and direction of the motion vector face the outer size. Also, as in the case of zoom out, in presuming of the displacement in the region of interest, an average value of the absolute size value of the motion vector in the region of interest is obtained, and in case the average value is larger than the preset critical value, it is regarded that there occurs movement (ST3). That is, by respectively obtaining displacement of the region of interest for four surfaces, the mode is decided as zoom in if the value heads the outer side (ST3 and ST4). Since the case of zoom indicates there occur changes in the screen, the value of displacement is calculated as the standard for changing the size of the region of interest (ST5).

Then, as shown in FIG. 4C, the size of the object for reducing the size of the enlarged region as large as the displacement value is maintained as a predetermined value (ST6 and ST7).

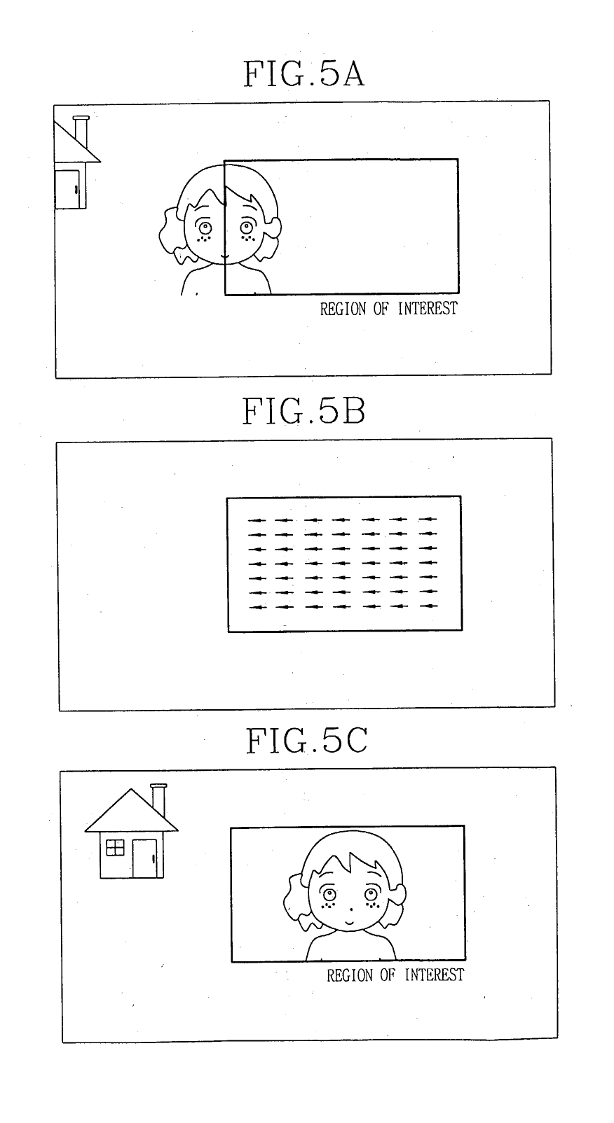

FIGS. 5A to 5C are exemplary views showing a state that the region of interest is moved in case the object on the screen is moved or the background region is moved.

As shown in FIGS. 5A to 5C, when the screen moves to the left direction, the size and direction of the motion vector heads the left size. Therefore, the region of interest also moves to the left.

The above operation will be described in more detail as follows.

Firstly, in case it is regarded that there are movements by presuming the generation of the displacement about the region of interest, but the mode is neither zoom in nor zoom out, the object on the screen is moved. Therefore, in case the position is changed as the object is moved, the center point of the enlarged region is moved so that the object is position at the center of the enlarged region, and accordingly, even if the contents of the screen is changed, the contents can be traced to show the contents (ST4, ST10 and ST11). That is, the position of the enlarged region is moved as the size and direction in the upper, lower, left and right directions so that the region of interest is positioned at the center of the screen. At this time, the direction of the displacement means a moving direction of the motion vector.

On the other hand, by the method of presuming generation of displacement of the region of interest, an average value of the absolute size value of the motion vector in the region of interest is obtained, and in case the average value is smaller than or same as the preset critical value, it is decided that there is movement of the background region except the region of interest (ST3 and ST9). Then, as the result of the above decision, the average value of the absolute size value of the motion vector corresponding to the background region is obtained, and if the average value is larger than the preset critical value, the position of the enlarged region is moved in the upper, lower, left and right directions so that the object is always positioned at the center of the enlarged region as it is regarded that there is movement of the camera (ST10 and S11).

As described above, the present invention improves the method for enlarging just stopped pictures or moving pictures having small amount of movement and prevents a case that an object or a region which was enlarged by a user can not be distinguished by zoom in or zoom out of the camera, thus to adjust the size of the enlarged region. Also, the position of the enlarged region can be moved according to the movement of the object in the region enlarged by the user. Also, the position of the enlarged region can be moved so that the object or the region which was enlarged by the user does not disappear out of the screen. Also, in case the object in the region of interest set by the user disappears out of the screen, the enlarged screen can be restored to the original screen.

Therefore, the method for tracing the enlarged region of the moving picture in accordance with the present invention can maintain the enlarged region by tracing the region, in case of enlarging a region of the object in which the user is interested by applying the method to digital TVs, DVDs, Video CD players and the like.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for tracing an enlarged region of a moving picture which reduces, enlarges or moves an enlarged region according to displacement of a region of interest on a screen.

2. The method of claim 1, comprising:
setting a region of interest on the basis of a center of the enlarged region set by the user; and
abstracting displacement corresponding to the region of interest in a MPEG stream.

3. The method of claim 2, further comprising:
restoring the enlarged, reduced or moved enlarged region into the original screen when an object in the region of interest disappears out of the screen.

4. The method of claim 1, wherein the region of interest is set as a half size of the enlarged area selected by the user.

5. The method of claim 1, wherein the displacement is a quantity of change according to a size and a direction of a motion vector for the region of interest.

6. The method of claim 5, wherein the motion vector reads parallel and vertical quantity of displacement between a current macro block and a macro block in a reference screen from the MPEG stream.

7. The method of claim 1, comprising:
deciding zoom in or zoom out when a displacement for the region of interest is occurred; and
calculating displacement by regarding there is changes in the screen when the result was zoom in as the result of the decision and reducing the changed value from the enlarged region.

8. The method of claim 7, wherein the displacement is obtained by calculating an average value of an absolute value of the motion vector corresponding to the region of interest, and when the average value is larger than a pre-set critical value, it is regarded that there occurred movement of the region of interest.

9. The method of claim 7, wherein the decision of the zoom in or zoom out is performed by direction of the motion vector of the region of interest.

10. The method of claim 7, wherein the decision of the zoom in or zoom out is performed by respectively obtaining the direction of the motion vector of the region of interest for 4 surfaces, when the value directs to the inner side, the screen is decided as zoom out, and when the value directs to the outer side, the screen is decided as zoom in.

11. The method of claim 1, comprising:
deciding zoom in or zoom out when a displacement for the region of interest is generated; and
calculating the displacement when the result is zoom out and enlarging the enlarged region as large as the displacement.

12. The method of claim 1, comprising:
deciding zoom in or zoom out when a displacement for the region of interest is generated; and
deciding that there is movement of the object on the screen when the result is not zoom in or zoom out, and moving the position of the region of interest in the upper, lower, left and right directions as the size and direction of the displacement.

13. The method of claim 12, wherein the direction is movement direction of a motion vector.

14. The method of claim 1, comprising:
deciding whether there is movement of a background region except the region of interest when the displacement of the region of interest is not occurred; and
calculating the displacement of the background region as the decision result, and moving the position of the region of interest as the displacement in the upper, lower, left and right directions so that the region of interest is always positioned at the center of the screen.

15. The method of claim 14, wherein the decision of the movement of the background region is performed by obtaining an average value of the absolute value of the motion vector in the region of interest, and deciding that there is movement of the background region except the region of interest when the average value is smaller than or same as the preset critical value.

16. The method of claim 14, wherein the average value of the absolute value of the motion vector in the background region is obtained as the result of the above decision, and the position of the region of interest is moved in the upper, lower, left and right directions so that the object is always positioned at the center of the enlarged region, as it is regarded that there is movement of a camera if the average value is larger than the preset critical value.

17. A method for tracing an enlarged region of a moving picture, comprising:
setting a region of interest on the basis of the center of an enlarged region which is set by a user;
reducing the enlarged region as a displacement by calculating the displacement in case the displacement is generated in the region of interest and the mode is zoom in;
enlarging the enlarged region as the displacement by calculating the displacement in case the displacement is generated in the region of interest and the mode is zoom out;
moving the position of the enlarged region in the upper, lower, left and right directions as long as the displacement by calculating the displacement if the displacement of the region of interest is occurred and the mode is not zoom in or zoom out; and
moving the position of the region of interest in the upper, lower, left and right directions so that the region of interest is always positioned at the center of the screen by calculating the displacement of the background region as the decision result when the displacement of the region of interest is not generated.

18. The method of claim 17, further comprising:
restoring the enlarged, reduced or moved enlarged region into the original screen in case an object in the region of interest disappears out of the screen.

19. The method of claim 17, wherein an average value of an absolute value of the motion vector corresponding to the region of interest is calculated, and in case the average value is larger than a pre-set critical value, it is regarded that there is movement of the region of interest.

20. The method of claim 17, wherein an average value of the absolute value of the motion vector in the region of interest is obtained, and it is decided that there is movement of the background region except the region of interest in case the average value is smaller than or same as a preset critical value.
